(19) United States
(12) Patent Application Publication
(10) Pub. No.: US 2016/0143812 A1
(43) Pub. Date: May 26, 2016

(54) PARTICLE-DOSING DEVICE

(71) Applicant: ASSISTANCE PUBLIQUE - HOPITAUX DE PARIS, Paris (FR)

(72) Inventor: Vincent Boudy, Paris (FR)

(73) Assignee: Assistance Publique - Hopitaux de Paris, Paris (FR)

(21) Appl. No.: 14/905,578

(22) PCT Filed: Jul. 16, 2014
(86) PCT No.: PCT/IB2014/063157

§ 371 Date: Jan. 15, 2016

(30) Foreign Application Priority Data
Jul. 17, 2013 (FR) 1357012

(51) Int. Cl. A61J 1/20; B65B 1/04

(52) U.S. Cl. CPC A61J 1/2096; B65B 1/04

(57) ABSTRACT

The invention relates to a device for dosing particles, especially medicaments in the form of microspheres, comprising: a store for the particles, comprising an opening and means for closing said opening; syringe-type dosing means comprising a tube and a piston which is slidably mounted in the tube, said means being detachably fixed to the store, at the opening; and means for transferring particles between the opening of the store and the dosing means, which are an integral part of the store, the dosing means being independent from the transfer means. The invention is characterized in that the transfer means can be actuated by a user in order to allow the particles to leave the store.

### TECHNICAL FIELD

The present invention relates to a device for dosing particles, and in particular, a dosing device intended for medicaments in the form of microspheres.

### SUMMARY

“Particles” refers to grains with a size comprised between 1 micron and 2 millimeters. These particles can therefore in particular appear in powdered form as microspheres.

In general, medicaments in aqueous form are less stable, biologically and chemically, than medicaments in dry form.

Thus, the stability of the latter is ensured without any need to provide preservatives.

Many devices have been proposed for dosing products in particle form.

For example, a dosing device comprising a reservoir for the particles, closed by a complementary part performing both the dosing and distribution of the particles.

To that end, this complementary part includes a syringe-type member with a cylindrical portion, in which a piston can be inserted. Furthermore, this cylindrical portion includes a pouring spout at its lower portion.

The piston in turn has two portions: a tube, and a rod clipped inside said tube, said rod being adapted to the quantity of product to be dosed.

Thus, the syringe-type member makes it possible to dose a quantity of product, owing to the piston, which is adapted to that specific quantity.

Thus, if such device must be able to be used to dose four different quantities of particles, it is necessary to have four different rods for the piston.

Furthermore, measuring a dose of medicament requires several successive operations, once the rod of the piston has been chosen and the piston has been inserted in the cylindrical portion:
rotating the piston to free the passage between the reservoir and the cylindrical portion,
rotating the device so that the reservoir is located above the syringe-type member and the granules can fall by gravity in the syringe-type member,
rotating the piston to block the passage between the container and the syringe-type member,
turning the device over, and lastly,
once again rotating the piston to free the passage between the latter and the pour spout and to allow the release of the dose of medicament.

This device allows effective dosing of medicaments, but is relatively complex to use.

Indeed, it requires having a plurality of pistons available, this number corresponding to the number of dosing operations that can be performed by the device.

Furthermore, the preparation of a medicament dose requires manipulations that are tedious for the user.

Furthermore, the additional part closing the container can easily be removed therefrom by the user. This creates risks of contamination of the particles present in the container.

The particles can also be contaminated due to the fact that previously dosed particles may not be distributed, but on the contrary remain in the syringe-type member and return to the container after dosing.

Embodiments of the present invention aim to offset these drawbacks, and/or others, by proposing a device for dosing particles that is simpler to use, that makes it possible to protect the particles from contamination risks, and that implements fewer parts.

Thus, embodiments of the invention relate to a device for dosing particles, in particular medicaments in the form of microspheres, comprising:
a reservoir for the particles comprising an opening and means for closing said opening,
syringe-type dosing means including a tube and a piston mounted sliding in the tube, these means being removably attached to the reservoir at the opening, and
means for transferring particles between the opening of the reservoir and the dosing means, which are an integral part of the reservoir, the dosing means being independent from the transfer means.

According to embodiments of the present invention, the transfer or closing means can be actuated by a user to allow the particles to leave the reservoir.

In a first alternative, the closing means and the transfer means are independent.

In a second alternative, the closing and transfer means are shared and in particular comprise a worm screw.

Preferably, the tube and the transfer means each include complementary connecting means able to cooperate with one another.

Advantageously, the reservoir has a flared shape from its opening, to facilitate the flow of the particles.

Preferably, the reservoir includes a complementary opening for filling with particles.

To avoid the inappropriate use of the dosing device, in particular by children, the closing and/or transfer means advantageously include a safety system.

To facilitate the dosing of the particles, the tube of the dosing means is preferably graduated.

Lastly, the dosing means are preferably intended for a single use.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

Embodiments of the present invention will be better understood and other aims, features and advantages thereof will appear more clearly upon reading the following description, done in reference to the appended drawings, in which:

FIG. 1 is a partial sectional side view of the dosing device according to an embodiment of the present invention, illustrating the container and the syringe-type member fixed on the container,

FIG. 2 illustrates the device of FIG. 1 during the dosing of the medicament, and

FIG. 3 illustrates the device of FIG. 1 with the syringe-type member detached from the container.

Members shared by the different figures will be designated using the same references.

### DETAILED DESCRIPTION

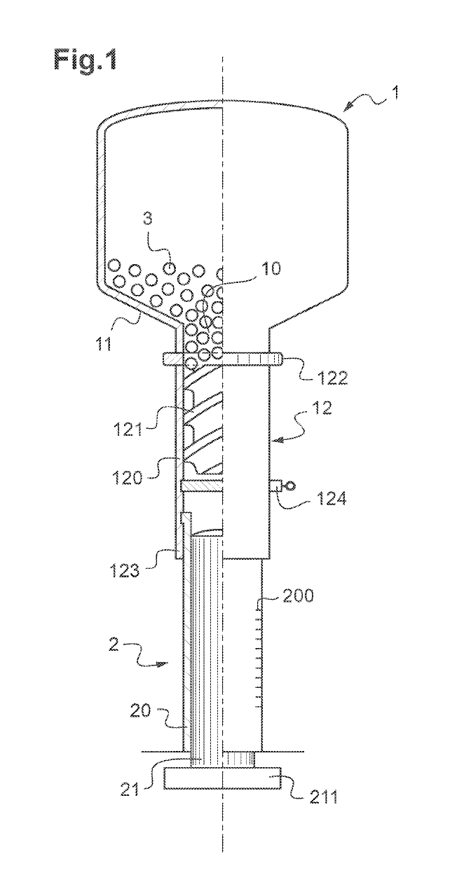

FIG. 1 illustrates a representative dosing device according to an embodiment of the present invention in its dosing position.

The device comprises a reservoir 1 that is filled with particles 3.

The container 1 includes an opening 10 through which the particles 3 can flow, and in the extension of the opening, transfer means 12.

The transfer means in the embodiment shown includes a cylindrical portion 120 in which a worm screw 121 is placed that can be actuated by a knob 122.

With such transfer means, the particles can only leave the container 1 if an action is performed by the user, in the case at hand, rotating the knob 122. In other words, without an action by the user, the particles 3 are blocked by the worm screw.

In this embodiment, the transfer means therefore perform a function both for closing the container 1 and for transferring particles from the inside of the container 1 toward the outside.

Closing means here refer to means that prevent particles from leaving the container, without the container necessarily being tight.

The device also comprises dosing means 2.

These means 2 are of the syringe type and include a tube 20 and a piston 21 slidingly mounted in the tube 20.

As illustrated in FIG. 1, the outer surface of the tube 20 preferably includes a graduation 200.

In the position illustrated in FIG. 1, the syringe-type member is fixed at the free end 123 of the tube 120.

This fixing is provided by various means, in particular by clipping or screwing.

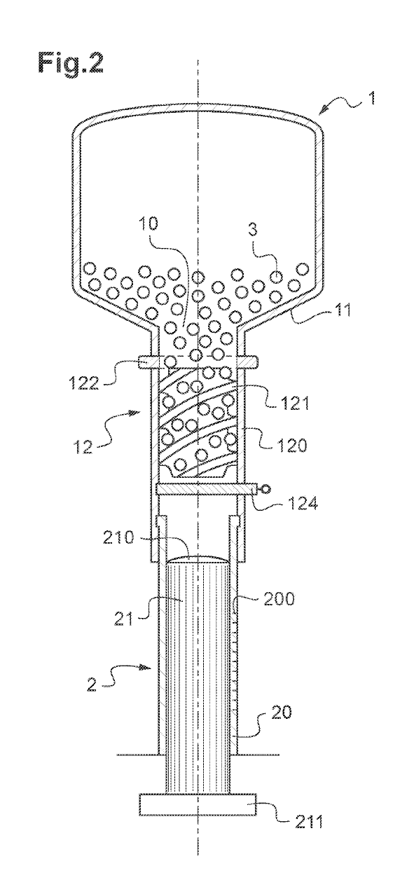

FIG. 2 illustrates the device according to an embodiment of the present invention during the dosing of the medicament.

During this operation, the user turns the knob 122 in order to actuate the worm screw 121 and thus cause the particles to pass in the cylindrical portion 120 until they reach the inner end 210 of the piston 21.

The user then pulls on the outer end 211 of the piston to cause it to slide in the tube 20.

The user rotates the knob 122 and translates the piston 21 until the piston 21 reaches the desired level in the graduation and the tube 20 is filled with particles 3 above that graduation.

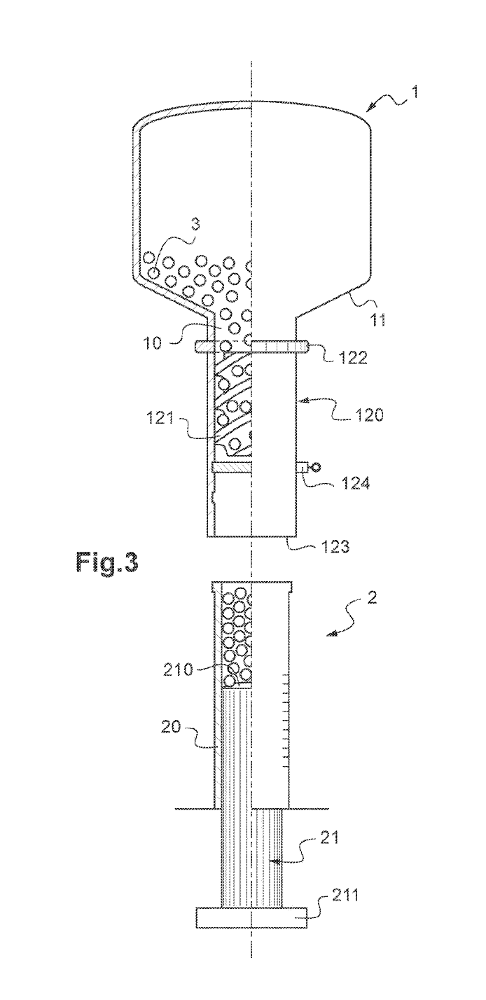

Once the desired dose of medicament is present in the dosing means 2, the latter is detached from the container. This is illustrated in FIG. 3.

The user can then administer the dose of medicament.

Furthermore, at the container 1, the particles are retained in the transfer means 12, using the worm screw.

When the medicament has been administered, the means 2 can be thrown away if they are intended for a single use. They can also be fixed on the container 1 again, for a new use.

The various figures show that the container 1 includes a beveled portion 11 around the opening 10.

Owing to this flared shape from the opening 10, the container facilitates the flow of particles toward the opening 10 and the transfer means 12.

Furthermore, in the illustrated example, the container is provided filled with particles. Thus, the container is thrown away once it is empty.

It is, however, possible to provide that the container 1 has an opening allowing it to be filled.

Furthermore, it is possible to place a dehydrating capsule in the container 1. Alternatively, the container can be made from a plastic material having dehydrating properties. This makes it possible to improve the preservation of the medicament.

The operation described above in reference to FIGS. 1 to 3 shows that the device according to embodiments of the present invention is very easy to use.

Furthermore, it prevents the manipulation of the dosing means from leading to opening of the container. Thus, the risks of contamination of the particles present in the container are avoided. This effect is obtained owing to the independence between the transfer means and the dosing means. The latter are independent from the reservoir, while the transfer means are an integral part of the reservoir.

Furthermore, the use of a worm screw, at the transfer means, prevents risks of back-contamination. Indeed, owing to this worm screw, no particle dosed in the dosing means can return to the container.

Thus, inasmuch as the transfer means must be actuated by a user to allow the particles to leave the reservoir, it is possible to effectively measure the doses of medicament to be delivered.

However, the present invention is not limited to this embodiment of the transfer means.

The latter can also consist solely of the cylindrical member 120. It is then necessary to provide closing means, at the opening 10 or between the opening and the free end 123 of the cylindrical portion 120, such as the gate 124.

A user can actuate these closing means to allow the passage of particles or, on the contrary, to block it.

In this other embodiment, it is also possible to provide a ramp inside the cylindrical portion 120 in order to control or slow the flow of the particles due to gravity.

It will be understood that, in this embodiment and its alternatives, the closing means for the container and the transfer means for the particles are independent of one another.

In several embodiments, the protection and preservation of the powdered products contained in the reservoir are ensured.

A safety system can also be provided to avoid an inappropriate use of the dosing device.

This safety system can for example be provided at the knob 122 or at the closing member when the latter is provided.

This safety system is not illustrated in the figures. Traditionally, it requires the user to perform two coordinated movements so as here to allow either the actuation of the knob or the opening of a gate, for example.

Furthermore, means can be provided to make the container, and therefore the dosing device, tamper-evident, i.e., possible to see if the device has been opened.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A device for dosing particles, comprising:
a reservoir configured to hold particles comprising an opening and means for closing said opening,
syringe-type dosing means including a tube and a piston slidingly mounted in the tube, said dosing means being removably attached to the reservoir at the opening, and
means for transferring particles between the opening of the reservoir and the dosing means, which are an integral part of the reservoir, the dosing means being independent from the transfer means,
wherein the transfer means can be actuated by a user to allow the particles to leave the reservoir.

2. The dosing device according to claim 1, wherein the closing means and the transfer means are independent.

3. The dosing device according to claim 1, wherein the closing and transfer means are shared.

4. The dosing device according to claim 1, wherein the tube and the transfer means each include complementary connecting means able to cooperate with one another.

5. The dosing device according to claim 1, wherein the reservoir has a flared shape from its opening.

6. The dosing device according to claim 1, wherein the reservoir includes a complementary opening for filling with particles.

7. The dosing device according to claim 1, wherein the closing and/or transfer means include a safety system.

8. The dosing device according to claim 1, wherein the tube of the dosing means is graduated.

9. The dosing device according to claim 1, wherein the dosing means are intended for a single use.

10. The dosing device according to claim 1, wherein the particles include at least one medicament in the form of microspheres.
